(19) United States
(12) Patent Application Publication
(10) Pub. No.: US 2014/0261207 A1
(43) Pub. Date: Sep. 18, 2014

(54) Container Water-Stopping Structure

(71) Applicants: Ke-Wei HO, Tainan City (TW); Wang-Jyun HO, Tainan City (TW)

(72) Inventors: Ke-Wei HO, Tainan City (TW); Wang-Jyun HO, Tainan City (TW)

(73) Assignee: ING DAH ENTERPRISE CO., LTD, Tainan City (TW)

(21) Appl. No.: 13/803,177

(22) Filed: Mar. 14, 2013

(51) Int. Cl. A01K 7/04

(52) U.S. Cl. CPC A01K 7/04
USPC 119/78

(57) ABSTRACT

A water-stopping structure for a container is disclosed. A float is provided in an internal space of a guiding element. A rod extending from one end of the float is movably received in a tube which penetrates an upper surface of the guiding element. A limiting element in which a water-stopping ball is movably received is mounted around the tube such that the water-stopping ball can be supported by the rod. A lower section of the guiding element is peripherally provided with grooves for guiding water out. A lower cover is mounted around an annular section concavely provided at a lower end of the guiding element. The water-stopping unit thus formed is connected to the bottom of a bucket and placed on a bottom plate so as to stop water from flowing from the bucket to the bottom plate when a predetermined water level is achieved in the bottom plate.

### BACKGROUND OF THE INVENTION

1. Field of the Invention

The present invention relates to a water-stopping structure for use with a container. The container is essentially a drinking water container for use with animals, such as pets, livestock, and the like. The predetermined water intake level of the drinking water container is controllable. The water-stopping structure comprises a water-holding bucket, a bottom plate, and a water-stopping unit coupled therebetween. Water is timely introduced into the bucket to feed animals. Alternatively, as soon as the water level in the bottom plate drops to a specific low level, water is introduced by means of the water-stopping unit.

2. Description of Related Art

Conventional water dispensers for use with animals, such as pets, livestock, and the like, usually comprise a bucket with predetermined capacity and shape, and a bottom plate. To enable the bucket and the bottom plate to hold water, it is necessary to turn over the bucket to hold clean water therein, turn over the bottom plate so as for the inverted bottom plate to be screwed and fastened to a lower end of the bucket such that the inverted bottom plate and the bucket together form a unitary structure, and position the water dispenser in a manner to allow the water dispenser to face squarely toward users such that water can be transferred from the bucket to the bottom plate via the outlet disposed at the lower rim of the bucket, thereby allowing the water dispenser to supply clean drinking water to pets and livestock.

Although, from a user's point of view, the water dispenser achieves the anticipated purpose of containing clean drinking water to be supplied to animals, such as pets, livestock, and the like, introducing water into the water dispenser is rather inconvenient, because the user has to turn over the bucket, turn over the bottom plate, and fasten the inverted bottom plate to the lower end of the bucket. As a result, not only is it time-consuming and inconvenient to introduce water into the water dispenser and install the water dispenser, the feed to the bottom plate of the water dispenser is determined by the water outlet height of the bucket and thus is fixed rather than adjustable.

Hence, the prior art attempted to solve the aforesaid problems facing the drinking water container. Referring to FIG. 1 and FIG. 2, the prior art provides a container water-stopping structure for use in supplying animal-oriented drinking water. The container water-stopping structure is provided in the form of a water dispenser 40 comprising a bucket 10 and a bottom plate 20. A float 30 positioned between a plurality of supporting elements 201 disposed on the bottom plate 20 is a hollow-core sphere with a predetermined outer diameter. The float 30 ascends as soon as the water 50 is transferred from the bucket 10 to the bottom plate 20 via a tube 101 disposed at the bottom of the bucket 10. The float 30 positioned between the supporting elements 201 abuts against the tube 101 disposed at the bottom of the bucket 10 and thereby clogs the tube 101, as soon as the float 30 moves together with the rising water level gradually to the lower side of the tube 101 disposed at the bottom of the bucket 10 (as shown in FIG. 11), such that the water 50 stops being transferred from the bucket 10 to the bottom plate 20 to thereby achieve a water-stopping status of a predetermined water intake level.

After the water level of the water in the bottom plate 20 of the water dispenser 40 has decreased because a portion of the water in the bottom plate 20 has been consumed by animals, the float 30 descends; hence, the water 50 is transferred again from the bucket 10 to the bottom plate 20 via the tube 101 disposed at the bottom of the bucket 10 to thereby replenish the water 50 in the bottom plate 20 at any time.

### SUMMARY OF THE INVENTION

The present invention is intended to improve the aforesaid prior art by putting forth a container water-stopping structure for use with animals' drinking water, so as for a water dispenser to control a predetermined water intake level. The container water-stopping structure is characterized in that: a water-stopping unit coupled between a water-holding bucket and a bottom plate; and water is timely transferred from the bucket to the bottom plate so as to be drunk by animals, or, alternatively, the water-stopping unit replenishes the water in the bottom plate as soon as the water in the bottom plate decreases to a specific low water level.

The first objective of the present invention is to provide a container water-stopping structure for use with animals' drinking water, characterized in that a drinking water container comprises a bucket and a bottom plate. A tube extending inward and outward is formed at the bottom of the bucket. A tough guiding element with a central hole is inserted tightly into the tube. A rod can be inserted movably into the central hole of the guiding element. A limiting element having therein a water-stopping ball is disposed around the upward-extending end of the guiding element. A water inlet is penetratingly disposed at the upward end of the limiting element. Branch portions each ending with a bending end are disposed at predetermine positions at the bottom of the bucket, respectively, and extend downward. A float can be held between supporting elements extending from a predetermined section of the bottom plate. Partition elements are disposed at predetermined positions on the bottom plate and positioned outside the supporting elements, respectively. The bending ends at the ends of the branch portions disposed at the bottom of the bucket and extending downward can be inserted into the partition elements and appropriately positioned therein. To put together the bucket and the bottom plate, it is necessary that the bending ends of the branch portions at the bottom of the bucket are inserted into the partition elements of the bottom plate, respectively, and appropriately positioned therein to thereby form a drinking water container. To allow the drinking water container to take in water, water is introduced into the bucket via an inlet at the upper end of the bucket to thereby allow the water to enter the bottom plate by passing through the water inlet of the limiting element and by being guided along by the guiding element. The float held between the supporting elements of the bottom plate is moved upward by water and thus drives the rod to push the water-stopping ball upward to thereby clog the water inlet of the limiting element, thereby effectuating water-stopping at a predetermined water intake level.

The second objective of the present invention is to provide a container water-stopping structure for use with animals' drinking water, characterized in that the supporting elements extending from predetermined sections of the bottom plate are provided in the form of a plurality of posts.

The third objective of the present invention is to provide a container water-stopping structure for use with animals' drinking water, characterized in that the supporting elements extending from predetermined sections of the bottom plate are provided in the form of an annular flange, and a groove is disposed circumferentially on one side of the annular flange.

The fourth objective of the present invention is to provide a container water-stopping structure for use with animals' drinking water, characterized in that partition elements, which are disposed at predetermined positions on the bottom plate and positioned outside the supporting elements, respectively, are each provided in the form of an abutting member having an upwardly-tapered space and each having an upward end at which a groove is formed, such that the branch portions extending downward from the bucket move inward along the grooves of the partition element, and thus the bending ends at the ends of the branch portions can be inserted into the space of the partition element.

The fifth objective of the present invention is to provide a container water-stopping structure for use with animals' drinking water, characterized in that the drinking water container for use with animals comprises the water-stopping unit for controlling the water intake level. The water-stopping unit comprises: a guiding element, a float, a water-stopping ball, a limiting element, and a lower cover. A space is formed in an upward interior of the guiding element and adapted to contain the float. One end of the float extends to form a rod to be inserted into a tube penetratingly disposed at an upper surface of the guiding element. Ribs are disposed circumferentially inside the tube of the guiding element, spaced apart from each other, and adapted to guide water in. The limiting element having therein the water-stopping ball is disposed around the upper outer rim of the tube of the guiding element, such that the rod of the float disposed inside the space of the guiding element can abut against the water-stopping ball. Grooves are disposed circumferentially at the lower section of the guiding element, spaced apart from each other, and adapted to guide water out. An annular section is disposed concavely at the outer rim of the lower end of the guiding element, so as for a lower cover to be disposed around the annular section, thereby forming the water-stopping unit. The water-stopping unit is coupled to the middle area at the bottom of the water-holding bucket and rests on a corresponding surface of the bottom plate such that, if the drinking water container needs to introduce water into the bottom plate, the float inside the water-stopping unit sinks and drives the water-stopping ball to move downward and separate from the water inlet at the upper end of the limiting element, such that the water from the bucket is introduced into the water-stopping unit via the limiting element, flows along the grooves disposed circumferentially at the lower section of the guiding element, and eventually enters the bottom plate to exercise control at a predetermined water intake level. As soon as the float inside the water-stopping unit is moved upward by the water from the bottom plate to thereby drive the water-stopping ball to abut against the water inlet at the upper end of the limiting element, an influx of the water from the bucket is stopped, such that water-stopping happens to the bottom plate of the drinking water container, allowing the water-stopping unit to feature ease of use.

The sixth objective of the present invention is to provide a container water-stopping structure for use with animals' drinking water, characterized in that a thread is formed circumferentially and outwardly at an upper section of the guiding element of the water-stopping unit and adapted to allow the water-stopping unit to be screwed to the middle area at the bottom of the bucket.

The seventh objective of the present invention is to provide a container water-stopping structure for use with animals' drinking water, characterized in that the water-stopping ball and a terminal end of the rod extending from an end of the float inside the water-stopping unit are integrally formed as a unitary structure, wherein the water-stopping ball is movable and capable of displacement within the tube at an upper end of the guiding element, such that the water-stopping unit is simple in structure.

### BRIEF DESCRIPTION OF THE SEVERAL VIEWS OF THE DRAWINGS

FIG. 1 (PRIOR ART) is an exploded view of a conventional container water-stopping structure;

FIG. 2 (PRIOR ART) is a front cross-sectional view of the conventional container water-stopping structure operating in a water-stopping mode;

FIG. 3 is an exploded view of a drinking water container according to the first embodiment of the present invention;

FIG. 4 is a front cross-sectional view of the drinking water container according to the first embodiment of the present invention;

FIG. 5 is a schematic view of the drinking water container operating in a water-intake mode according to the first embodiment of the present invention;

FIG. 6 is a schematic view of the drinking water container operating in a water-stopping mode according to the first embodiment of the present invention;

FIG. 7 is an exploded view of a drinking water container according to the second embodiment of the present invention;

FIG. 8 is a schematic view of the drinking water container operating in a water-intake mode according to the second embodiment of the present invention;

FIG. 9 is a schematic view of the drinking water container operating in a water-stopping mode according to the second embodiment of the present invention;

FIG. 10 is an exploded view of the water-stopping unit;

FIG. 11 is a cross-sectional view of the water-stopping unit;

FIG. 12 is a schematic view of the water-stopping unit disposed at between the bucket and the bottom plate;

FIG. 13 is a schematic view of the water-stopping unit disposed at the bucket and operating in a water-intake mode;

FIG. 13A is an enlarged view of portion A in FIG. 13;

FIG. 14 is a schematic view of the water-stopping unit disposed at the bucket and operating in a water-stopping mode according to the second embodiment of the present invention;

FIG. 14A is an enlarged view of portion A in FIG. 14; and

FIG. 15 is an exploded view of the water-stopping unit according to the second embodiment of the present invention.

### DETAILED DESCRIPTION OF THE EMBODIMENTS OF THE INVENTION

The present invention provides a container water-stopping structure (as shown in FIG. 3) embodied in a drinking water container 5 adapted for use with animals, such as pets and livestock. The drinking water container 5 comprises a bucket 1 and a bottom plate 3.

The bucket 1 has a bottom with a tube 11 (as shown in FIG. 4) extending inward and outward. A tough guiding element 2 with a central hole 21 is inserted tightly into the tube 11. A rod 22 can be inserted movably into the central hole 21 of the guiding element 2. A limiting element 24 having therein a water-stopping ball 23 is disposed around the upward end of the guiding element 2. A water inlet 241 is penetratingly disposed at the upward end of the limiting element 24. Branch portions 12 each ending with a bending end 121 are disposed at predetermine positions at the bottom of the bucket 1, respectively, and extend downward.

Supporting elements 31 (shown in FIG. 3 and provided in the form of a plurality of posts) extend from a predetermined section of the bottom plate 3, such that a float 4 can be held between the supporting elements 31. Partition elements 32 are disposed at predetermined positions on the bottom plate 3 and positioned outside the supporting elements 31, respectively. The partition elements 32 are each provided in the form of an abutting member having an upwardly-tapered space 321 and each having an upward end at which a groove 322 is formed. The bending ends 121 at the ends of the branch portions 12 disposed at the bottom of the bucket 1 and extending downward can be inserted into the space 321 and the groove 322 and appropriately positioned therein.

To put together the bucket 1 and the bottom plate 3 (as shown in FIG. 3, FIG. 4), it is necessary to guide the branch portions 12, which are disposed at the bottom of the bucket 1 and extend downward, inward along the groove 322 of the partition element 32 of the bottom plate 3, such that the bending ends 121 at the ends of the branch portions 12 are inserted into the space 321 of the partition element 32 and thus appropriately positioned therein, thereby finalizing the drinking water container 5.

Referring to FIG. 5, to introduce water into the drinking water container 5, it is necessary to take in water via the inlet at the upper end of the bucket 1 and thus allow the water 9 to be admitted via the water inlet 241 of the limiting element 24 at the bottom of the bucket 1 and guided into the bottom plate 3 via the central hole 21 of the guiding element 2, and in consequence water can be introduced into the drinking water container 5 conveniently.

Referring to FIG. 6, in a water-stopping mode, once the incoming water 9 in the bottom plate 3 reaches a predetermined water level, the float 4 in the bottom plate 3 will be moved upward by the water 9 to cause the rod 22 to push the water-stopping ball 23 upward and thereby clog the water inlet 241 of the limiting element 24, thereby effectuating water-stopping at a predetermined water intake level.

Once the water 9 in the bottom plate 3 of the drinking water container 5 has been consumed by the animals to such an extent that the water level has dropped, the float 4 will descend to thereby move the rod 22 and the water-stopping ball 23 downward (as shown in FIG. 5); as a result, the water 9 will be transferred from the bucket 1 to the bottom plate 3 via the water inlet 241 at the bottom of the limiting element 24 and the central hole 21 of the guiding element 2, thereby replenishing the water 9 in the bottom plate 3 at any time.

Referring to FIG. 7, in the second embodiment of the present invention, a container water-stopping structure is characterized in that the drinking water container 5 comprises the bucket 1 and the bottom plate 3 which are slightly different from their counterparts in the first embodiment of the present invention illustrated with FIG. 3 in: the supporting elements extending from a predetermined section of the bottom plate 3 are provided in the form of an annular flange 33, and a groove 331 is disposed circumferentially on one side of the annular flange 33. The float 4 is disposed in the groove 331 (as shown in FIG. 8), such that the water 9 admitted via the water inlet 241 of the limiting element 24 at the bottom of the bucket 1 is transferred to the bottom plate 3 via the central hole 21 of the guiding element 2 and the groove 331 disposed circumferentially on one side of the annular flange 33, thereby introducing the water 9 into the drinking water container 5 conveniently.

The float 4 held between the supporting elements 31 of the bottom plate 3 is moved upward by the water 9 and thus drives the rod 22 to push the water-stopping ball 23 upward to thereby clog the water inlet 241 of the limiting element 24 (as shown in FIG. 9), thereby effectuating water-stopping at a predetermined water intake level.

Referring to FIG. 10, a container water-stopping structure according to the third embodiment of the present invention is the drinking water container 5 for use with animals, wherein a water-stopping unit 8 for controlling a water intake level comprises a guiding element 6, a float 7, a water-stopping ball 67, a limiting element 68, and a lower cover 69.

The guiding element 6 is a hollow-core element with a bottom hollowed out upward to form a space 61. A tube 62 is penetratingly disposed at the upper surface of the guiding element 6. Ribs 63 are disposed circumferentially inside the tube 62 of the guiding element 6, spaced apart from each other, and adapted to guide water in. Grooves 64 are disposed circumferentially at the lower section of the guiding element 6, spaced apart from each other, and adapted to guide water out. An annular section 65 is disposed concavely at the outer rim of the lower end of the guiding element 6. A thread 66 is formed circumferentially and outwardly at the upper section of the guiding element 6.

The float 7 is contained in the space 61 of the guiding element 6 and adapted to control the water intake level. One end of the float 7 extends to form a rod 71.

The water-stopping ball 67 abuts against the rod 71 formed at one end of the float 7 to effectuate water-stopping.

The limiting element 68 determines the receipt of the water-stopping ball 67 according to the tube 62 at the upper surface of the guiding element 6. A water inlet 681 is penetratingly disposed at the upper end of the limiting element 68.

The lower cover 69 determines the positioning and coverage of the float 7 according to the annular section 65 at the lower end of the guiding element 6.

The process of putting together the guiding element 6, the float 7, the water-stopping ball 67, the limiting element 68, and the lower cover 69 (as shown in FIG. 10, FIG. 11) comprises the steps of: (step 1) putting the float 7 in the upward internal space 61 of the guiding element 6 such that the rod 71 extending from one end of the float 7 is contained in the tube 62 penetratingly disposed at the upper surface of the guiding element 6; (step 2) putting the water-stopping ball 67 in the limiting element 68 to allow the limiting element 68 to be disposed around the upper outer rim of the tube 62 of the guiding element 6; and (step 3) disposing the lower cover 69 around the annular section 65 disposed concavely at the outer rim of the lower end of the guiding element 6, thereby finalizing the assembly of a water-stopping unit 8 (as shown in FIG. 11).

Due to the thread 66 at the upper section of the guiding element 6, the water-stopping unit 8 can be screwed to a screw nut 14 coupled beforehand to a middle area 13 at the bottom of the bucket 1 (as shown in FIG. 12). The lower end of the water-stopping unit 8 rests on a corresponding surface of the bottom plate 3.

The water-stopping unit 8, which is screwed to the middle area 13 at the bottom of the bucket 1 and rests on a corresponding surface of the bottom plate 3, operates in conjunction with the drinking water container 5 in introducing the water 9 into the bottom plate 3 (as shown in FIG. 13, FIG. 13A) in a process as follows: the float 7 inside the water-stopping unit 8 sinks and drives the water-stopping ball 67 to move downward and separate from the water inlet 681 at the upper end of the limiting element 68, such that the water 9 from the bucket 1 is introduced into the water-stopping unit 8 via the limiting element 68, flows along the grooves 64 disposed circumferentially at the lower section of the guiding element 6, and eventually enters the bottom plate 3 to exercise control at a predetermined water intake level.

As soon as the float 7 inside the water-stopping unit 8 screwed to the middle area 13 at the bottom of the bucket 1 and resting on a corresponding surface of the bottom plate 3 is moved upward by the water 9 from the bottom plate 3 to thereby drive the water-stopping ball 67 to abut against the water inlet 681 at the upper end of the limiting element 68 (as shown in FIG. 14, FIG. 14A), an influx of the water 9 from the bucket 1 is stopped, and in consequence water-stopping happens to the bottom plate 3 of the drinking water container 5 at a predetermined water intake level timely. Hence, the water-stopping unit 8 features ease of use.

Referring to FIG. 15, according to the present invention, a water-stopping ball 72 and the terminal end of the rod 71 extending from one end of a float 7′ inside the water-stopping unit 8′ screwed to the middle area at the bottom of the bucket and resting on a corresponding surface of the bottom plate are integrally formed as a unitary structure, wherein the water-stopping ball 72 is movable and capable of displacement within a tube 62′ at the upper end of a guiding element 6′, such that the water-stopping unit 8′ is simple in structure.

What is claimed is:

1. A container water-stopping structure, comprising:
a bucket having a bottom with a tube extending inward and outward, allowing a tough guiding element with a central hole to be inserted tightly into the tube, allowing a rod to be inserted movably into the central hole of the guiding element, wherein a limiting element having therein a water-stopping ball is disposed around an upward end of the guiding element, wherein a water inlet is penetratingly disposed at an upward end of the limiting element, wherein branch portions each ending with a bending end are disposed at predetermine positions at the bottom of the bucket, respectively, and extend downward; and
a bottom plate, wherein supporting elements extend from a predetermined section of the bottom plate, such that a float can be held between the supporting elements, wherein partition elements are disposed at predetermined positions on the bottom plate and positioned outside the supporting elements, respectively, such that the bending end at the ends of the branch portions extending downward from the bucket can be inserted into the partition elements and appropriately positioned therein,
wherein putting together the bucket and the bottom plate entails inserting the bending ends at the ends of the branch portions at the bottom of the bucket into the partition elements of the bottom plate to effectuate positioning and thereby form a drinking water container, wherein introducing water into the drinking water container entails taking in water via an inlet at an upper end of the bucket and thus allowing the water to be admitted via the water inlet of the limiting element at the bottom of the bucket and guided into the bottom plate via the guiding element, such that the float in the bottom plate will be moved upward by the water to cause the rod to push the water-stopping ball upward and thereby clog the water inlet of the limiting element, thereby effectuating water-stopping at a predetermined water intake level.

2. The container water-stopping structure of claim 1, wherein the supporting elements extending from a predetermined section of the bottom plate are provided in form of posts.

3. The container water-stopping structure of claim 1, wherein the supporting elements extending from a predetermined section of the bottom plate are provided in form of an annular flange, and a groove is disposed circumferentially on a side of the annular flange.

4. The container water-stopping structure of claim 1, wherein the partition elements disposed on the bottom plate and positioned outside the supporting elements, respectively, are each provided in form of an abutting member having an upwardly-tapered space and each having an upward end at which a groove is formed, such that the bending ends at the ends of the branch portions extending downward from the bucket can be inserted into the spaces of the partition elements whenever the branch portions move inward along the grooves of the partition elements.

5. A container water-stopping structure, for use with an animal-oriented drinking water container in controlling a water intake level, is characterized in that a water-stopping unit comprises a guiding element, a float, a water-stopping ball, a limiting element, and a lower cover,
wherein the guiding element is hollowed out upward to form a space for receiving the float, wherein an end of the float extends to form a rod to be contained in a tube penetratingly disposed at an upper surface of the guiding element, wherein ribs are disposed circumferentially inside the tube of the guiding element, spaced apart from each other, and adapted to guide water in, wherein the limiting element having therein the water-stopping ball is disposed around the tube disposed at the upper surface of the guiding element, such that the rod of the float positioned inside the space of the guiding element can abut against the water-stopping ball, wherein a water inlet is penetratingly disposed at an upper end of the limiting element, wherein grooves are disposed circumferentially at a lower section of the guiding element, spaced apart from each other, and adapted to guide water out, wherein an annular section is disposed concavely at an outer rim of a lower end of the guiding element, so as for a lower cover to be disposed around the annular section, thereby forming the water-stopping unit,
wherein the water-stopping unit is coupled to the middle area at the bottom of a water-holding bucket and rests on a corresponding surface of a bottom plate such that, if the drinking water container needs to introduce water into the bottom plate, the float inside the water-stopping unit sinks and drives the water-stopping ball to move downward and separate from the water inlet at the upper end of the limiting element, such that the water from the bucket is introduced into the water-stopping unit via the limiting element, flows along the grooves disposed circumferentially at the lower section of the guiding element, and eventually enters the bottom plate to exercise control at a predetermined water intake level,
wherein, as soon as the float inside the water-stopping unit is moved upward by the water from the bottom plate to thereby drive the water-stopping ball to abut against the water inlet at the upper end of the limiting element, an influx of the water from the bucket is stopped, such that water-stopping happens to the bottom plate of the drinking water container, allowing the water-stopping unit to feature ease of use.

6. The container water-stopping structure of claim 5, wherein a thread is formed circumferentially and outwardly at an upper section of the guiding element of the water-stopping unit and adapted to allow the water-stopping unit to be screwed to the middle area at the bottom of the bucket.

7. The container water-stopping structure of claim 5, wherein the water-stopping ball and a terminal end of the rod extending from an end of the float inside the water-stopping unit are integrally formed as a unitary structure, wherein the water-stopping ball is movable and capable of displacement within the tube at an upper end of the guiding element, such that the water-stopping unit is simple in structure.
